(19) United States
(12) Patent Application Publication
(10) Pub. No.: US 2010/0211621 A1
(43) Pub. Date: Aug. 19, 2010

(54) WEB-BASED ORGANIZATION OF ONLINE ADVERTISING CONTENT

(75) Inventors: Vivek Hariharan, Sunnyvale, CA (US); Johnny Wang, Santa Clara, CA (US); Ameya Virkar, Santa Clara, CA (US); Graham S.T. Harris, Westlake Village, CA (US); Treven Ho, Los Angeles, CA (US)

Correspondence Address: FIALA & WEAVER, P.L.L.C.;C/O CPA GLOBAL, P.O. BOX 52050, MINNEAPOLIS, MN, 55402, US

(73) Assignee: Yahoo! Inc., Sunnyvale, CA (US)

(21) Appl. No.: 12/388,937

(22) Filed: Feb. 19, 2009

(51) Int. Cl. G06F 17/30; G06Q 30/00

(52) U.S. Cl. 707/829; 707/E17.001; 707/E17.044; 705/14.73

(57) ABSTRACT

A system, method, and computer program product are provided that enable organization of online advertising content, such as online ads, creatives, and templates, using a Web-based hierarchical folder structure. The hierarchical folder structure includes a plurality of folders among which the online ad content may be organized. The hierarchical folder structure is accessible to one or more advertisers, publishers, or representatives thereof via the World Wide Web.

### BACKGROUND OF THE INVENTION

1. Field of the Invention

The present invention generally relates to the organization of online advertising content using the World Wide Web. In particular, the present invention is related to a Web-based organization module providing a hierarchical folder structure for organizing online ad content that includes at least one of advertisements (“ads”), creatives, or templates that can be used to generate ads.

### BACKGROUND

Certain online advertisement (“ad”) networks enable online ads to be served to users visiting the Web sites of publishers that are participating in the online ad network. Advertisers generate the online ads and buy placements for those ads on the publishers' Web sites usually based on the anticipated audiences for those sites. A placement represents a publisher's agreement to serve a specified ad to users when the users visit the publisher's site. The publisher often serves the specified ad contemporaneously with other content associated with the publisher's site.

Each time a user visits a Web site, an impression is said to occur. The impression causes an ad call (also referred to as an impression call) to be generated. The ad call initiates retrieval of the specified ad, which the publisher serves to the user in fulfillment of the purchased placement. Traditionally, the ad is stored locally on an ad serving system where it may not be accessible for purposes other than serving to users who visit the publisher's Web site. For example, in conventional online ad networks, advertisers or representatives acting on their behalf may not be able to access previously submitted ads for use in other advertising campaigns. Each time an advertiser wishes to traffic an ad after purchasing placements, the advertiser may be required to go through the process of generating a new ad, even if the ad already exists. Conventional online ad networks therefore often do not allow re-use or re-purposing of online advertising content, such as the ads themselves or creatives thereof. A creative is well known in the relevant art(s) to be a media component of an online ad. For example, the creative may be an audio component, an image component, and/or a video component of an online ad.

Moreover, conventional online ad networks often do not include a central repository that is capable of providing access to ads or creatives for all members of a distributed team. Only those members having access to the local storage of the ad serving system are able to access the ads, and the creatives often are not accessible independently from the ads. Furthermore, the ads and creatives may not be stored in a structured manner, leading to difficulty in finding a particular ad or creative. Even if the storage of the ads is structured, the online ad network may not provide the capability of organizing the ads or creatives within the structure.

Thus, systems, methods, and computer program products are needed that address one or more of the aforementioned shortcomings of conventional online ad networks.

### BRIEF SUMMARY OF THE INVENTION

A system, method, and computer program product are described herein for providing Web-based organization of online advertising content, such as online advertisements (“ads”), creatives, and templates that can be used to generate ads. Embodiments of the present invention utilize a Web-based hierarchical folder structure to organize the online ad content.

By enabling Web-based organization of the online ad content, an embodiment of the present invention can advantageously provide one or more advertisers, publishers, or representatives thereof access to the online ad content via the World Wide Web and enable utilization of the online ad content for generation of new ads and for subsequent ad campaigns.

In particular, a method is described in which a Web-based hierarchical folder structure is provided. The Web-based hierarchical folder structure is accessible to a plurality of remote users via the World Wide Web. Online ad content is organized among a plurality of folders in the Web-based hierarchical folder structure in response to a command received from a remote user of the plurality of remote users. Another method is described in which online ad content is provided to a Web-based hierarchical folder structure that is accessible to a plurality of remote users via the World Wide Web. The online ad content is organized among a plurality of folders in the Web-based hierarchical folder structure.

A computer program product is also described herein. The computer program product includes a computer-readable medium having computer program logic recorded thereon for enabling a processor-based system to organize online advertising content in a Web-based hierarchical folder structure that is accessible to a plurality of remote users on the World Wide Web. The computer program logic includes a first program logic module and a second program logic module. The first program logic module is for enabling the processor-based system to provide the Web-based hierarchical folder structure. The second program logic module is for enabling the processor-based system to organize the online ad content among a plurality of folders in the Web-based hierarchical folder structure in response to a command received from one or more of the plurality of remote users.

A system is also described herein. The system includes a content management processing module and a storage. The storage is coupled to the content management processing module for storing a database, a first organizational operation module, and a second organizational operation module. The database is configured to store online ad content. The first organizational operation module is configured to provide a Web-based hierarchical folder structure including the online ad content that is accessible to a plurality of remote users on the World Wide Web. The second organizational operation module is configured to organize the online ad content among a plurality of folders in the Web-based hierarchical folder structure in response to a command received from one or more of the plurality of remote users.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate the present invention and, together with the description, further serve to explain the principles of the invention and to enable a person skilled in the relevant art(s) to make and use the invention.

FIG. 1 is a block diagram of an example online advertisement (“ad”) network in accordance with an embodiment of the present invention.

FIG. 2 is a block diagram of an example implementation of the organization module shown in FIG. 1 in accordance with an embodiment of the present invention.

FIG. 3 is an example representation of a hierarchical folder structure in accordance with an embodiment of the present invention.

FIGS. 4 and 5 depict flowcharts of methods for organizing online ad content in accordance with embodiments of the present invention.

FIGS. 6-10 depict screenshots of an example user interface for enabling a user to organize online ad content among folders of a hierarchical folder structure in accordance with embodiments of the present invention.

FIG. 11 is a block diagram of a computer system that may be used to implement one or more aspects of the present invention.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE INVENTION

### A. Introduction

The following detailed description refers to the accompanying drawings that illustrate exemplary embodiments of the present invention. However, the scope of the present invention is not limited to these embodiments, but is instead defined by the appended claims. Thus, embodiments beyond those shown in the accompanying drawings, such as modified versions of the illustrated embodiments, may nevertheless be encompassed by the present invention.

References in the specification to “one embodiment,” “an embodiment,” “an example embodiment,” or the like, indicate that the embodiment described may include a particular feature, structure, or characteristic, but every embodiment may not necessarily include the particular feature, structure, or characteristic. Moreover, such phrases are not necessarily referring to the same embodiment. Furthermore, when a particular feature, structure, or characteristic is described in connection with an embodiment, it is submitted that it is within the knowledge of one skilled in the art to implement such feature, structure, or characteristic in connection with other embodiments whether or not explicitly described.

### B. Example Online Advertising Network

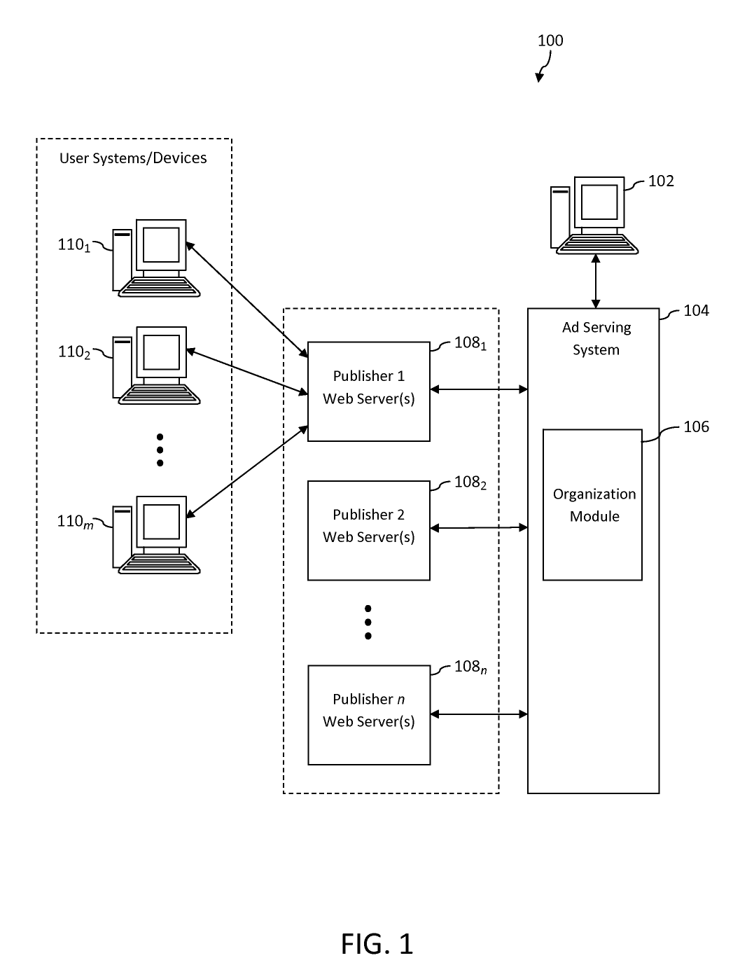

FIG. 1 is a block diagram of an example online advertisement (“ad”) network in accordance with an embodiment of the present invention. Generally speaking, online ad network 100 operates to serve online ads provided by advertisers to Web sites published by publishers when such Web sites are accessed by certain users of the network, thereby delivering the online ads to the users. As shown in FIG. 1, online ad network 100 includes at least one advertiser system/device 102, an ad serving system 104, a plurality of publisher Web servers 108₁-10ₙ, and a plurality of user systems/devices 110₁-110dₘ.

Each of publisher Web servers 108₁-108ₙ is configured to host a Web site published by corresponding publisher 1-n so that such Web site is accessible to users of network 100. A user may access such Web sites using a Web browser or other Web client installed on a system/device owned by or otherwise accessible to the user. By way of example, FIG. 1 shows a plurality of user systems/devices 110₁-110ₘ, each of which executes a Web browser that enables a user to visit any of the Web sites hosted by publisher Web servers 108₁-108ₙ. As depicted in FIG. 1, each of client systems/devices 110₁-110ₘ is communicatively connected to publisher 1 Web server(s) 108₁ for the purpose of accessing a Web site published by publisher 1. Persons skilled in the relevant art(s) will recognize that each of user systems/devices 110₁-110ₘ is capable of connecting to any of publisher Web servers 108₁-108ₙ to access the Web sites hosted thereon. Communication between user systems/devices 110₁-110m and publisher Web servers 108₁-108ₙ is carried out over a wide area network, such as the Internet, using well-known network communication protocols.

Ad serving system 104 is configured to deliver online ads received from an advertiser system/device 102 to each of publisher Web servers 108₁-108ₙ when the Web sites hosted by such Web servers are accessed by certain users, thereby facilitating the delivery of such online ads to the users. In accordance with embodiments described herein, ad serving system 104 includes an organization module 106 that advantageously enables the online ads and other online ad content, such as creatives or templates, that are received from advertiser system/device 102 to be organized and stored in a Web-based hierarchical folder structure. For instance, the online content received from advertiser system/device 102 may be organized and/or stored among a plurality of folders in the hierarchical folder structure before being delivered to a publisher Web server.

An advertiser may upload online ad content to organization module 106 using a Web browser or other Web client installed on advertiser system/device 102, which is owned by or otherwise accessible to the advertiser. Advertiser system/device 102 executes the Web browser, enabling the advertiser to view the hierarchical folder structure and to designate an appropriate folder(s) thereof in which the online ad content is to be stored. Once organization module 106 stores the online ad content in the designated folder(s), the advertiser or any other authorized entity may view and organize the uploaded online ad content among the plurality of folders in the hierarchical folder structure using a respective advertiser system/device.

Organization module 106 may be configured to copy creatives of online ads received from advertiser system/device 102 for storage and/or organization independently from the online ads themselves. In some instances, advertiser system/device 102 may deliver creatives, rather than or in addition to complete ads, to organization module 106. Organization module 106 may be configured to distinguish between complete online ads and creatives and to store and/or organize each accordingly in the hierarchical folder structure stored in organization module 106.

Communication between advertiser system/device 102 and organization module 106 is carried out over a wide area network, such as the Internet, using well-known network communication protocols. Although one advertiser 102 system/device is depicted in FIG. 1, persons skilled in the relevant art(s) will recognize that any number of advertiser system/devices may be communicatively coupled to ad serving system. For instance, the hierarchical folder structure may be accessible to one or more advertisers, publishers, or representatives thereof via respective advertiser system/devices. A publisher may have access to the hierarchical folder structure whether acting on its own behalf or acting as an agent or by proxy on behalf of an advertiser.

Organization module 106 enables an advertiser or representative thereof to designate Ad Groups to which online ads stored in the hierarchical folder structure are to be assigned. An Ad Group is a collection of ads having a similar target audience and/or pricing model. Organization module 106 is configured to store ad metadata corresponding to the online ads and placement metadata corresponding to placements against which the online ads may be run. Organization module 106 matches the ad metadata and the placement metadata to ensure that an appropriate ad from a corresponding Ad Group is served for a given impression. If an ad does not face competition for impressions, organization module 106 may serve the ad so long as the ad satisfies the specifications of the corresponding placement(s). If multiple ads are competing for the impressions, however, organization module 106 may consider criteria such as performance, price, campaign goals, etc. to determine which ad to serve.

When the Web sites hosted by the publisher Web servers 108₁-108ₙ are accessed by the users, organization module 106 retrieves the online ads from the corresponding Ad Groups and delivers the online ads to the respective publisher Web servers 108₁-108ₙ. In another implementation, organization module 106 generates an online ad based on a stored creative before delivering the online ad to the respective publisher Web server(s). In yet another implementation, organization module 106 retrieves the creative from a remote source based on software code stored in the hierarchical folder structure before generating the online ad based on the creative. Each of the publisher Web servers 108₁-108ₙ is configured to serve the online ads along with Web site content to the users.

In still another implementation, each publisher Web server 108₁-108ₙ is configured to embed a request to organization module 106 along with the Web site content served to certain users. In response to the execution of the embedded request by the Web browser running on the user system/device, organization module 106 delivers an online ad to the user within the context of the Web site content. In this implementation, a direct connection is established between the user system/device and organization module 106 (not shown in FIG. 1). This direct connection may also be established over a wide area network such as the Internet.

Although advertiser system/device 102 and user systems/devices 110₁-110ₘ are depicted as desktop computers in FIG. 1, persons skilled in the relevant art(s) will appreciate that advertiser system/device 102 and user systems/devices 110₁-110ₘ may include any browser-enabled system or device, including but not limited to a laptop computer, a personal digital assistant, a cellular telephone, or the like.

### C. Example Organization Module

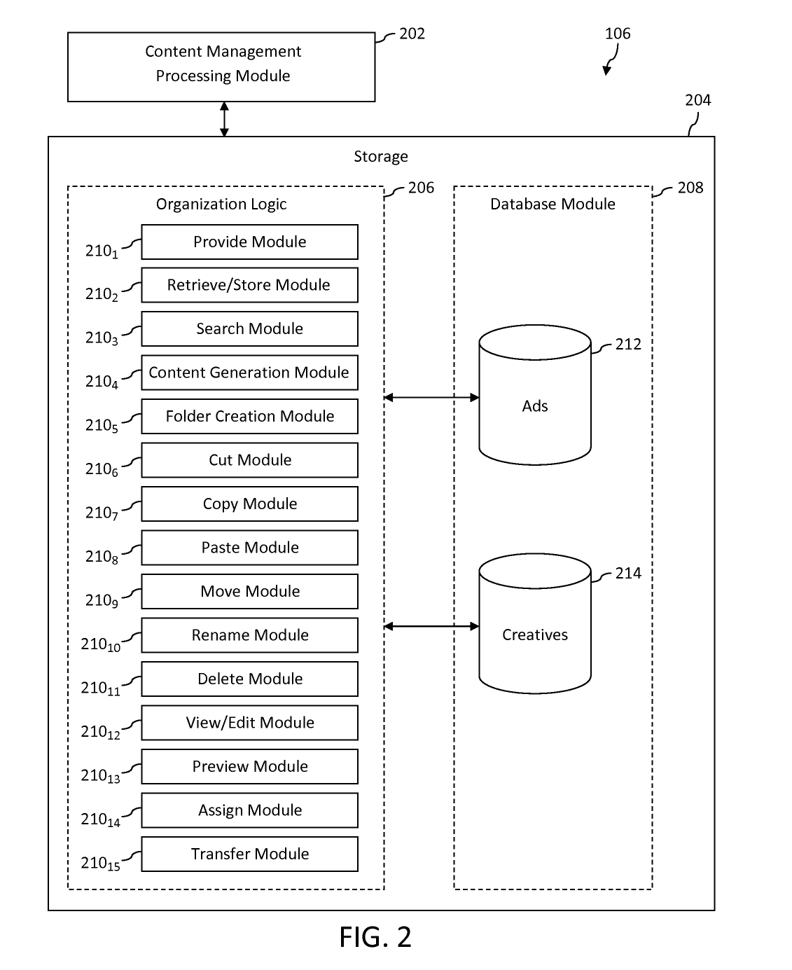

FIG. 2 is a block diagram of an example implementation of organization module 106 shown in FIG. 1 in accordance with an embodiment of the present invention. In FIG. 2, organization module 106 includes a content management processing module 202 that includes one or more processors (e.g., one or more central processing units (CPUs)) and a storage 204 that are communicatively connected for organizing online ad content, such as online ads, creatives, and templates, provided by one or more advertisers or representatives thereof via respective advertiser systems/devices, as shown of FIG. 1. Storage 204 includes organization logic 206 and database module 208. Organization logic 206 includes organizational operation modules 210₁-210₁₅, each of which includes instructions to enable content management processing module 202 to perform a respective organizational operation. The instructions of each organizational operation module need not necessarily be limited to that particular organizational operation module. For instance, organizational operation modules 210₁-210₁₅ may share instructions.

Example organizational operations will now be discussed with reference to organizational operation modules 210₁-210₁₅. Provide module 210₁ enables content management processing module 202 to provide a Web-based hierarchical folder structure that is accessible to a plurality of remote users via the World Wide Web.

When organization module 106 receives online ad content from an advertiser or representative thereof, content management processing module 202 stores the online ad content in database module 208 in accordance with instructions stored in retrieve/store module 210₂. Retrieve/store module 210₂ may be configured to enable content management processing module 202 to distinguish between different types of received online ad content. For instance, retrieve/store module 210₂ may enable content management processing module 202 to distinguish between online ads and creatives and to store the online ads and creatives in the respective ads database 212 and creatives database 214.

It will be recognized that database module 208 may include other databases, such as a templates database. For example, retrieve/store module 210₂ may enable content management processing module 202 to distinguish between online ads, creatives, and templates and to store the online ads, creatives, and templates in the respective ads database 212, creatives database 214, and templates database.

Content management processing module 202 may copy the creative portion of a received online ad into creatives database 214 in accordance with instructions stored in retrieve/store module 210₂ to facilitate subsequent generation of a new ad based on the creative. For instance, content management processing module 202 need not extract a creative from a stored ad at the time a new ad is to be generated. Rather, the creative is readily available for inclusion in a new ad without the need for accessing ads database 212, thereby reducing the time and effort required to generate the new ad. Moreover, the complete ad is available in ads database 212 if the extent of changes to be made to the ad is minor enough that making the changes to the ad itself is preferred.

Retrieve/store module 210₂ may be configured to enable content management processing module 202 to retrieve online ad content, such as a creative, from a third party source. For instance, content management processing module 202 may store a piece of code that represents the online content and then retrieve the online content based on the stored code in accordance with instructions stored in retrieve/store module 210₂.

Content management processing module 202 enables an advertiser, publisher, or representative thereof to conduct a search of the hierarchical folder structure in accordance with instructions stored in search module 210₃. For example, an advertiser may search for a folder and/or online ad content, such as an online ad, creative, or template in the hierarchical folder structure by providing appropriate search criteria.

Content management processing module 202 generates online ads based on online ad content, such as creatives or templates, stored in database module 208 or retrieved from a third party system. For instance, content generation module 210₄ may be configured to enable content management processing module 202 to generate an online ad that includes a creative hosted on a third party system in response to content management processing module 202 retrieving the creative from the third party system in accordance with instructions stored in the retrieve/store module 210₂.

Folder creation module 210₅ enables content management processing module 202 to create a folder in the hierarchical folder structure. Cut module 210₆ enables content management processing module 202 to cut a branch, folder, online ad, creative, template, other online ad content, or some combination thereof from the hierarchical folder structure. A branch of the hierarchical folder structure includes a folder and at least one sub-folder and/or item of online ad content stored in the folder and/or sub-folder.

Copy module 210₇ enables content management processing module 202 to copy a branch, folder, online ad, creative, template, other online ad content, or some combination thereof in the hierarchical folder structure to a designated folder of the hierarchical folder structure. Paste module 210₈ enables content management processing module 202 to paste a specified branch, folder, online ad, creative, template, other online ad content, or some combination thereof to a designated folder of the hierarchical folder structure. Move module 210₉ enables content management processing module 202 to move a specified branch, folder, online ad, creative, template, other online ad content, or some combination thereof from a first folder of the hierarchical folder structure to a second folder of the hierarchical folder structure.

Rename module 210₁₀ enables content management processing module 202 to rename a folder, online ad, creative, template, or other online ad content of the hierarchical folder structure. Delete module 210₁₁ enables content management processing module 202 to delete a specified branch, folder, online ad, creative, template, other online ad content, or some combination thereof from the hierarchical folder structure.

Content management processing module 202 enables an advertiser, publisher, or representative thereof to view and edit descriptive information pertaining to a folder, online ad, creative, template, or other online ad content of the hierarchical folder structure in accordance with instructions stored in view/edit module 210₁₂. Content management processing module 202 enables an advertiser, publisher, or representative thereof to preview online ad content, such as an online ad, creative, or template, in accordance with instructions stored in preview module 210₁₃. Content management processing module 202 enables an advertiser or representative thereof to assign online ad content to an Ad Group in accordance with instructions in assign module 210₁₄.

Although only a single ads database 212 and a single creatives database 214 are shown in FIG. 2, persons skilled in the relevant art(s) will appreciate that the online ads and creatives may be stored in multiple ads databases and multiple creatives databases, respectively. Each online ad or creative provided by an advertiser may be associated with a particular ad campaign sponsored by the advertiser.

In FIG. 2, organization logic 206 and database module 208 are shown to be included in a single storage 204 for illustrative purposes. However, it will be apparent to persons skilled in the relevant art(s) that storage 204 may include a plurality of storages, each storing at least a portion of organization logic 206 and/or database module 208. Any one or more processors of content management processing module 202 may be communicatively connected to respective portions of organization logic 206 and/or database module 208. For instance, transfer module 210₁₅ is configured to enable content management processing module 202 to transfer a branch, folder, online ad, creative, template, or other online ad content among the plurality of storages.

In one example implementation, a first server includes at least one processor of content management processing module 202 and one or more organizational operation module(s) of organization logic 206. A second server includes another at least one processor of content management processing module 202, other organizational operation module(s) of organization logic 206, and database module 208. The first server may receive online ad content from advertiser system/device 102. An organizational operation module, such as transfer module 210₁₅, stored on the first server may be configured to provide the online ad content to the second server for processing the online ad content in accordance with the organizational techniques described herein. For instance, the organizational operation module stored on the first server may provide the online content to a Web-based hierarchical folder structure stored in database module 208 of the second server. The organizational operation module(s), such as retrieve/store module 210₂, stored on the second server may be configured to store the online ad content in the database module 208 among a plurality of folders in the Web-based hierarchical folder structure. This example implementation is provided for illustrative purposes and is not intended to be limiting.

It will be apparent to persons skilled in the relevant art(s) that other implementations fall within the scope of the present invention.

Storage 204 may be of any suitable type, including but not limited to random access memory (RAM), such as static RAM (SRAM), dynamic RAM (DRAM), ferroelectric RAM (FeRAM), magnetoresistive RAM (MRAM), resistive RAM (RRAM), or nano-RAM (NRAM); read only memory (ROM), such as programmable ROM (PROM), erasable programmable ROM (EPROM), or electrically erasable programmable ROM (EEPROM); flash memory; optical storage media, such as a compact disc (CD), digital versatile disc (DVD), or Blue-ray disc; programmable metallization cell (PMC); phase-change memory (PCM); silicon-oxide-nitride-oxide-silicon (SONOS); racetrack memory; etc.

Note that organization logic 206 may include any one or more of organizational operation modules 210₁-210₁₅, each of which may be implemented in hardware, software, firmware, or any combination thereof. For example, any one or more of organizational operation modules 210₁-210₁₅ may be implemented as computer code configured to be executed in one or more processors. In another example, any one or more of organizational operation modules 210₁-210₁₅ may be implemented as hardware logic/electrical circuitry. In yet another example, any one or more of organizational operation modules 210₁-210₁₅ may be implemented as firmware embedded in one or more hardware devices. In still another example, any one or more of organizational operation modules 210₁-210₁₅ may be implemented as a combination of computer code, hardware logic/electrical circuitry, and/or firmware.

Organizational operation modules 210₁-210₁₅ are provided for illustrative purposes and are not intended to be limiting. Organization logic 206 may include organizational operation module(s) other than the organizational operation modules 210₁-210₁₅ discussed above. The other organizational operation module(s) may also be implemented in hardware, software, firmware, or any combination thereof.

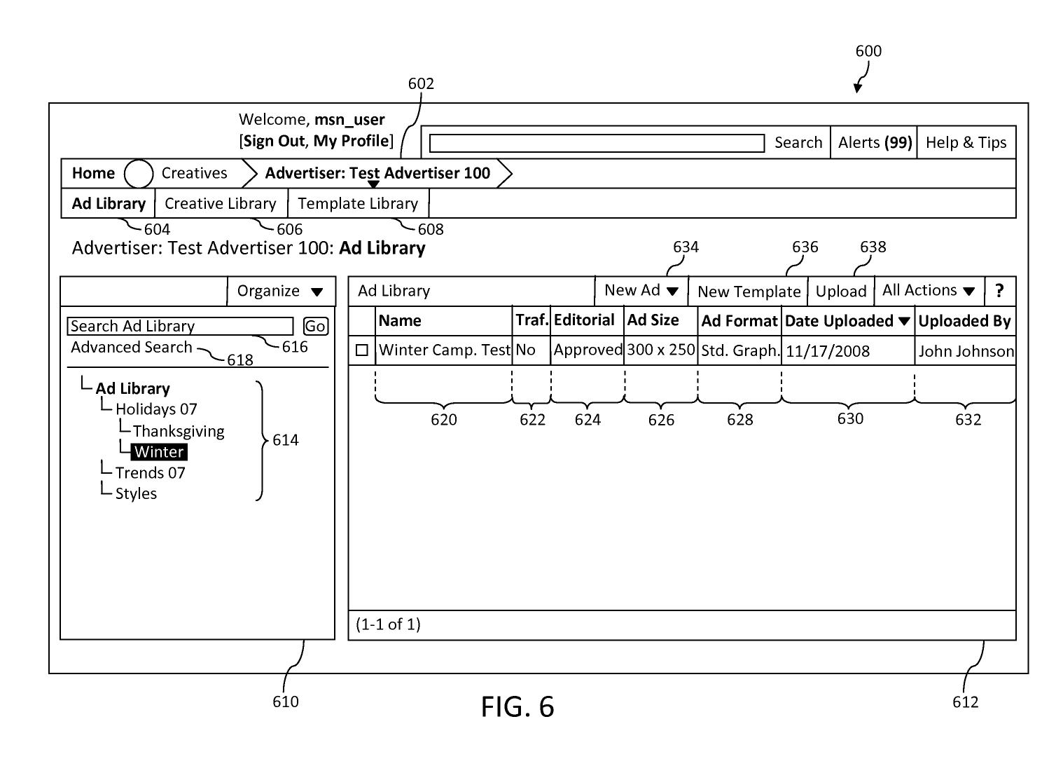

The example organizational operations discussed above with reference to organizational operation modules 210₁-210₁₅ are described in greater detail below in section E of the present application with reference to screenshots 600-1000 of FIGS. 6-10.

### D. Example Hierarchical Folder Structure

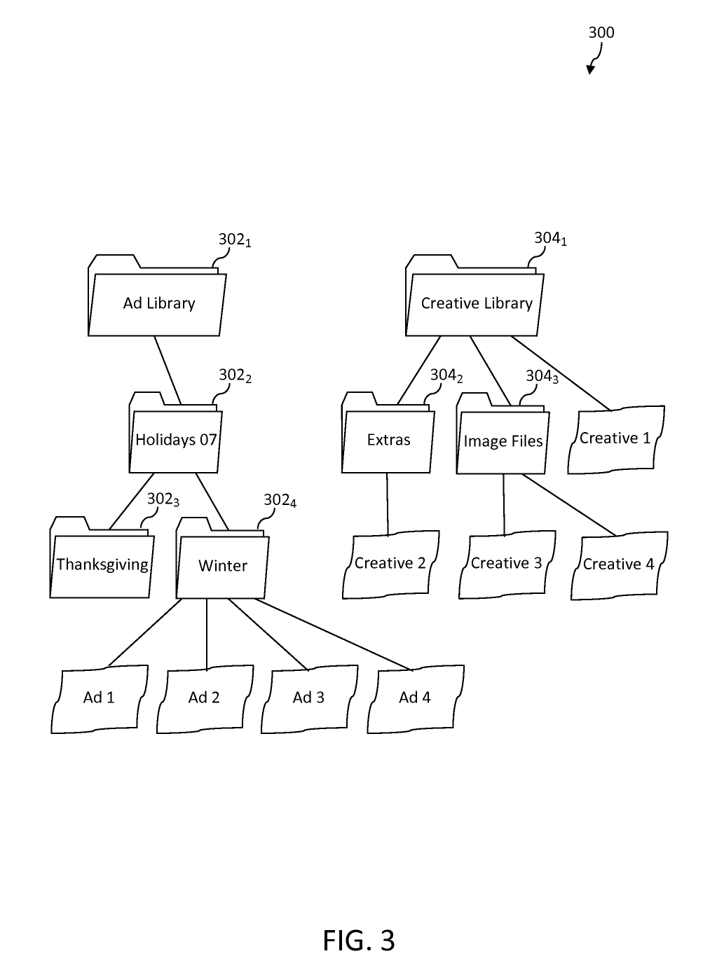

FIG. 3 is an example representation of a hierarchical folder structure 300 in accordance with an embodiment of the present invention. Hierarchical folder structure 300 includes an Ad Library root folder 302₁ and a Creative Library root folder 304₁. The ads stored in ads database 212 of FIG. 2 are organized among the Ad Library root folder 302₁ and sub-folders 302₂-302₄ thereof. The creatives stored in creatives database 214 of FIG. 2 are organized among the Creative Library root folder 304₁ and sub-folders 304₂-304₃ thereof. In FIG. 3, Ad Library root folder 302₁ includes sub-folder 302₂ labeled “Holidays 07”, which includes sub-folders 302₃-302₄ respectively labeled “Thanksgiving” and “Winter”. Sub-folder 302₄ is shown to include four ads respectively labeled “Ad1”, “Ad2”, “Ad3”, and “Ad4”.

Creative Library root folder 304₁ includes a creative labeled “Creative 1” and two sub-folders 304₂-304₃ respectively labeled “Extras” and “Image Files”. Sub-folder 304₂ includes one creative labeled “Creative 2”. Sub-folder 304₃ includes two creatives respectively labeled “Creative 3” and “Creative 4”.

Hierarchical folder structure 300 is provided for illustration purposes and is not intended to be limiting. Persons skilled in the relevant art(s) will recognize that hierarchical folder structure 300 may include any number of folders, sub-folders, ads, and creatives. While ads and creatives are organized in separate branches of hierarchical folder structure 300 in FIG. 3, it should be noted that the ads and creatives may be organized in the same branch(es) of hierarchical folder structure 300. For instance, it may be desirable to store ads and creatives together within a branch or folder designated for a particular advertising campaign, especially if the advertising campaign involves relatively few ads and/or creatives.

It should be further noted that hierarchical folder structure 300 may include other root folders, such as a Template Library root folder. For instance, templates stored in a templates database of database module 208 may be organized among the Template Library root folder and sub-folders thereof.

### E. Organizing Online Ad Content in the Hierarchical Folder Structure

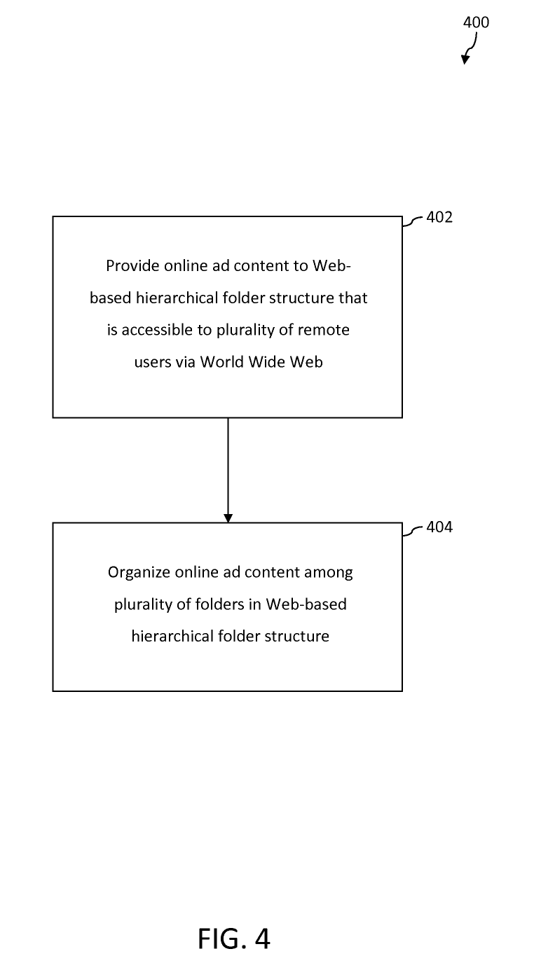

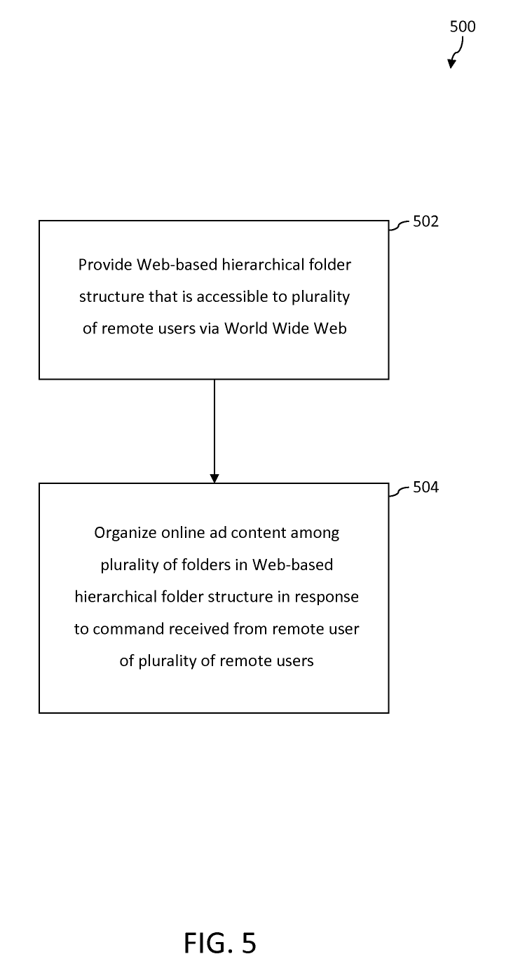

Some example methods for organizing online ad content will now be described with reference to flowcharts 400 and 500 of respective FIGS. 4 and 5 in accordance with embodiments of the present invention. These methods are described by way of example only and are not intended to limit the scope of the present invention. The method of flowchart 400 is described from the perspective of a user (e.g., an advertiser or representative thereof) accessing organization module 106; whereas, the method of flowchart 500 is described from the perspective of a provider of organization module 106.

As shown in FIG. 4, the method of flowchart 400 begins at step 402 in which online ad content is provided to a Web-based hierarchical folder structure that is accessible to a plurality of remote users via the World Wide Web. For example, a user may log into a computer system that stores the Web-based hierarchical folder structure. Upon obtaining authorization from the computer system to access the hierarchical folder structure, the user may upload the online ad content to the computer system for inclusion in the hierarchical folder structure. The online ad content may be a complete ad, a creative, a template, or some other portion of an online ad. In an example implementation, transfer module 210₁₅ of organization logic 206 may be configured to enable content management processing module 202 to provide the online ad content.

Access to the hierarchical folder structure may be limited those remote users having the appropriate rights/permissions. For instance, access may be role-based, such that certain permissions are assigned to roles and to the users designated for performing those roles. In one example implementation, a library of creatives, ads, or templates may be associated with a specific entity (e.g., advertiser, publisher, etc.), and only users having access to the specific entity and having the appropriate rights/permissions are allowed to access the library and associated data.

At step 404, the online ad content is organized among a plurality of folders in the Web-based hierarchical folder structure. For instance, the user may perform any of a variety of organizational operations, including but not limited to creating a folder in the hierarchical folder structure to store the online ad content; moving or copying the online ad content from one folder to another; deleting the online ad content from a folder of the hierarchical folder structure; copying, moving, or deleting a folder in the hierarchical folder structure, etc. In an example implementation, any one or more of the organizational operation modules 210₂-210₁₅ described above with reference to FIG. 2 may enable content management processing module 202 to organize the online ad content among the plurality of folders.

Referring now to FIG. 5, a Web-based hierarchical folder structure is provided at step 502. The hierarchical folder structure is accessible to a plurality of remote users on the World Wide Web. For example, content management processing module 202 of organization module 106 may provide the Web-based hierarchical folder structure in accordance with instructions stored in provide module 210₁ of organization logic 206. While organization module 106 may be configured to generate a user interface for facilitating use of the hierarchical folder structure by the plurality of remote users, a user may nevertheless generate another user interface to use in lieu of the user interface generated by organization module 106.

At step 504, online ad content is organized among a plurality of folders in the Web-based hierarchical folder structure in response to a command received from a remote user of the plurality of remote users. For instance, content management processing module 202 may organize the online ad content in accordance with instructions stored in any one or more of the organizational operation modules 210₂-210₁₅ described above with reference to FIG. 2 when an advertiser, publisher, or representative thereof provides an appropriate command to organization module 106.

Database module 208 of organization module 106 may include a look-up table that cross-references user commands and organizational operations. For example, each command may correspond to a respective organizational operation, some of which are described in greater detail below with reference to screenshots 600-1000 shown in FIGS. 6-10.

FIGS. 6-10 depict screenshots 600-1000 of an example user interface for enabling a user (e.g., an advertiser, publisher, or representative thereof) to organize online ad content among folders of a hierarchical folder structure, such as Web-based hierarchical folder structure 300 shown in FIG. 3, according to embodiments of the present invention. Organization module 106 serves the user interface in the form of Web pages to a Web browser of a system/device, such as advertiser system/device 102, which displays the user interface to the user in the Web browser. The user interface illustrated by screenshots 600-1000 is provided by way of example and is not intended to be limiting. It will be apparent to persons skilled in the relevant art(s) that a user may utilize any suitable user interface to access the Web-based hierarchical folder structure and ad content stored therein. Moreover, the user interface need not necessarily be provided by organization module 106. For instance, the user interface may be generated by the user.

Referring to FIG. 6, a user designated as “msn_user” is logged into a computer system that provides access to the Web-based hierarchical folder structure. For example, content management processing module 202 may execute instructions stored in provide module 210₁ of FIG. 2 to provide access to the Web-based hierarchical structure. The user is authorized to access online content for any provider listed in provider list drop down menu 602. The online content for a selected provider is accessible via Ad Library 604 and Creative Library 606. Ad Library 604 includes online ads of the selected provider, and Creative Library 606 includes creatives of the selected provider. Template Library 608 includes templates for creating an online ad. A template is a predefined process that enables a user to generate an online ad within a given framework more efficiently than generating the ad free-form. For example, the user can utilize the template to generate an online ad having a specified size, file weight, format, etc. One or more creatives stored in Creative Library 606 may be combined with a template stored in Template Library 608 to generate an online ad. For instance, content management processing module 202 may execute instructions stored in content generation module 210₄ to generate the online ad.

In FIG. 6, Ad Library 604 of the provider “Test Advertiser 100” is selected, causing a hierarchical listing 614 of the folders designated for storing online ads of Test Advertiser 100 to appear in window 610. When a folder in window 610 is selected, the online ads that are stored in that folder appear in window 612. For example, sub-folder “Winter” is selected in window 610, and the only ad stored in the Winter sub-folder (i.e., the ad named “Winter Camp. Test”) appears in window 612. The hierarchical listing 614 of folders in window 610 is searchable by using search tool 616. Advanced Search tool 618 enables a user to search the hierarchical listing 614 of folders by specifying a name and/or one or more characteristics of the sought folder(s), thereby filtering the hierarchical listing 614. For instance, content management processing module 202 may execute instructions stored in search module 210₃ of FIG. 2 to provide the functionality associated with search tool 616 and/or Advanced Search tool 618.

When the name of an online ad is listed in window 612, indicators associated with that ad are listed as well. As shown in FIG. 6, the name of each ad is listed in column 620. In column 622, a trafficking indicator specifies whether the ad has been trafficked. For instance, the trafficking indicator is set to “Yes” if the ad has been delivered to a publisher for serving to a user when the user visits the publisher's Web site. If the ad has not been delivered to a publisher for serving to a user, the trafficking indicator is set to “No.” An editorial indicator is provided in column 624 to indicate the extent to which the ad is ready to be trafficked. If the ad has not been submitted for trafficking, the editorial indicator is set to “Not Submitted.” If the ad has been submitted, the editorial indicator is set to “Pending” if the ad has not been approved for trafficking. The editorial indicator is set to “Approved” if the ad has been both submitted and approved for trafficking. In column 626, an ad size indicator specifies the dimensions of the ad.

The ad may have any of a variety of formats, including but not limited to standard graphical, video, flash, rich media, etc. In column 628, an ad format indicator specifies the format of each ad. For instance, the ad named “Winter Camp. Test” is listed as having a standard graphical format in column 628. The date that the ad was uploaded to the computer system is specified in column 630. The name of the individual who uploaded the ad is provided in column 632.

New Ad drop down menu 634 enables a user to generate a new online ad by selecting a stored ad from Ad Library 604, a creative from Creative Library 606, or a template from Template Library 608. The user can then modify the selected ad, creative, or template to generate the new ad. New Template button 636 enables the user to generate a new ad template. For instance, content management processing module 202 may provide the functionality associated with New Ad drop down menu 634 and/or New Template button 636 in accordance with instructions stored in content generation module 210₄ of FIG. 2.

Upload button 638 enables the user to upload an ad to the computer system that stores the online ad content of the hierarchical folder structure or to some other computer system designated to receive the uploaded ad. For example, content management processing module 202 may upload the ad in accordance with instructions stored in retrieve/store module 210₂ of FIG. 2 in response to the user selecting upload button 638.

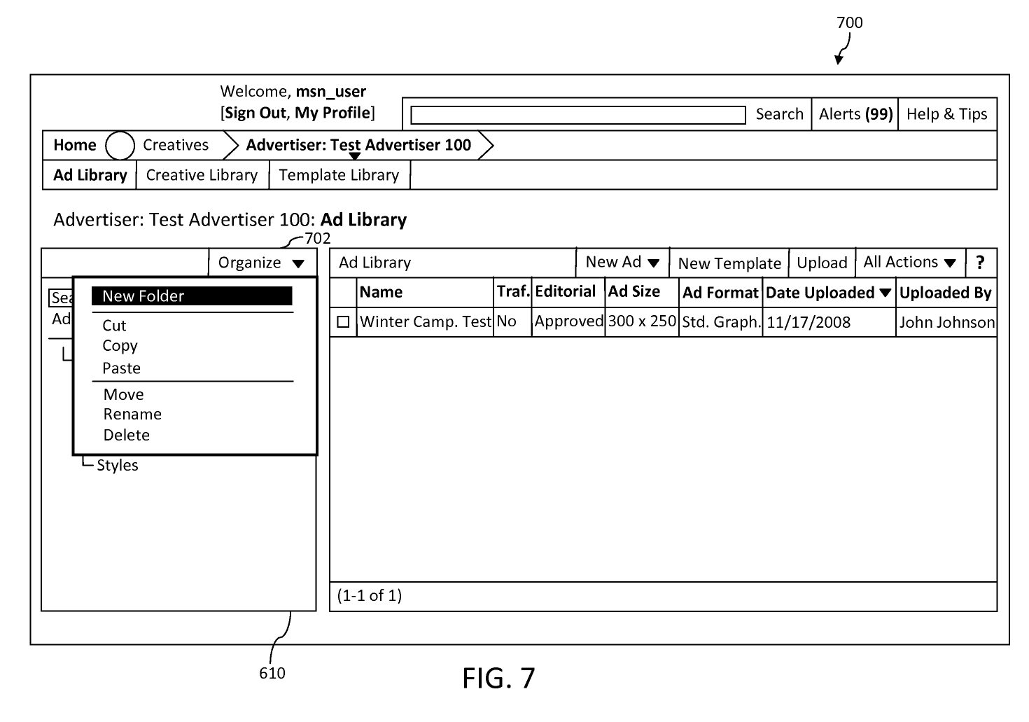

Referring now to FIG. 7, Organize drop down menu 702 enables a user to perform operations on folders of the hierarchical folder structure. As shown in FIG. 7, the “New Folder” item in Organize drop down menu 702 enables a user to create a new folder within the hierarchical folder structure. For instance, content management processing module 202 may execute instructions stored in folder creation module 210₅ of FIG. 2 to create the new folder in response to the user selecting the “New Folder” item.

In one example implementation, referred to as inline folder creation, the new folder is stored in a highlighted folder in window 610, and the user is then given an opportunity to change the name of the new folder. For instance, content management processing module 202 may store the new folder in accordance with instructions stored in retrieve/store module 210₂. Content management processing module 202 may then enable the user to change the name of the new folder in accordance with instructions stored in rename module 210₁₀.

In another example implementation, referred to as dialog folder creation, the user is prompted to enter a name and location for the new folder before the new folder is stored in the hierarchical folder structure. For instance, content management processing module 202 may execute instructions stored in retrieve/store module 210₂ of FIG. 2 to provide the functionality associated with dialog folder creation.

The “Cut” item in Organize drop down menu 702 enables a user to cut a folder from the hierarchical folder structure. For example, content management processing module 202 may cut the folder in accordance with instructions stored in cut module 210₆ of FIG. 2 in response to the user selecting the “Cut” item.

A user can copy a folder from a first folder to a second folder within the hierarchical folder structure using the “Copy” item of Organize drop down menu 702. For instance, content management processing module 202 may execute instructions stored in copy module 210₇ of FIG. 2 to copy the folder in response to the user selecting the “Copy” item.

The “Paste” item enables a user to paste a folder in the hierarchical folder structure. For instance, a previously cut or copied folder may be pasted into a selected folder in window 610. For instance, content management processing module 202 may paste the folder in accordance with instructions stored in paste module 210₈ of FIG. 2 in response to the user selecting the “Paste” item.

The “Move” item enables a user to move a folder from a first folder to a second folder within the hierarchical folder structure. For example, content management processing module 202 may execute instructions stored in move module 210₉ of FIG. 2 to move the folder in response to the user selecting the “Move” item.

A user can rename a folder using the “Rename” item of Organize drop down menu 702. For example, content management processing module 202 may rename the folder in accordance with instructions stored in rename module 210₁₀ of FIG. 2 in response to the user selecting the “Rename” item.

The “Delete” item enables a user to delete a folder from the hierarchical folder structure. For instance, content management processing module 202 may delete the folder in accordance with instructions stored in delete module 210₁₀ of FIG. 2 in response to the user selecting the “Delete” item.

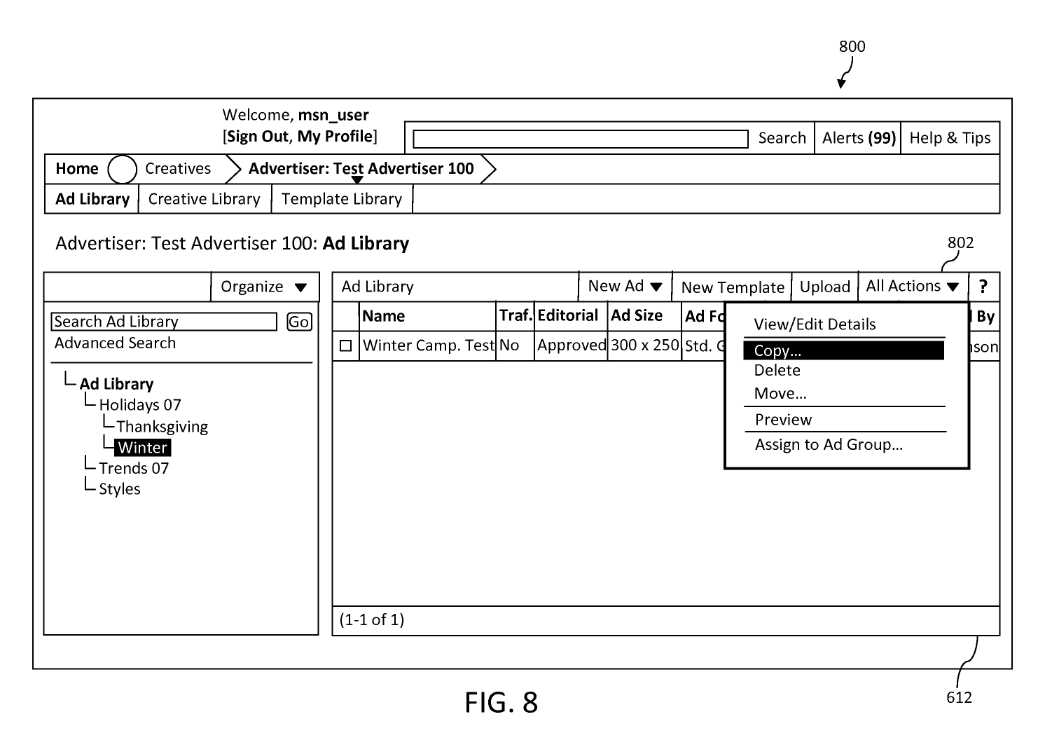

As shown in FIG. 8, All Actions drop down menu 802 enables a user to perform operations on ads stored in the hierarchical folder structure. For instance, the “View/Edit Details” item in All Actions drop down menu 802 enables a user to view and edit the name and indicators associated with each ad listed in window 612, as described above with reference to columns 620-632 of FIG. 6. For example, content management processing module 202 may enable the user to view and edit the name and indicators in accordance with instructions stored in view/edit module 210₁₂ of FIG. 2 in response to the user selecting the “View/Edit Details” item.

The “Copy . . . ” item enables a user to copy an online ad from a first folder to a second folder of the hierarchical folder structure. For instance, content management processing module 202 may copy the online ad in accordance with instructions stored in copy module 210₇ of FIG. 2 in response to the user selecting the “Copy . . . ” item.

A user can delete an ad from the hierarchical folder structure using the “Delete . . . ” item. For example, content management processing module 202 may execute instructions stored in delete module 210₁₀ of FIG. 2 to delete the online ad in response to the user selecting the “Delete . . . ” item.

The “Move . . . ” item enables a user to move an online ad from a first folder to a second folder of the hierarchical folder structure. For instance, content management processing module 202 may execute instructions stored in move module 210₉ of FIG. 2 to move the online ad in response to the user selecting the “Move . . . ” item.

A user can preview an ad using the “Preview” item. For instance, a portion or the entirety of the ad may be presented to the user. The ad may be presented in the context of a Web site selected by the user. For example, content management processing module 202 may enable the user to preview the online ad in accordance with instructions stored in preview module 210₁₃ of FIG. 2 in response to the user selecting the “Preview” item.

A user may assign an ad to an Ad Group using the “Assign to Ad Group . . . ” item of All Actions drop down menu 802. For example, content management processing module 202 may assign the ad to the Ad Group in accordance with instructions stored in assign module 210₁₄ of FIG. 2 in response to the user selecting the “Assign to Ad Group . . . ” item. Once the user assigns an ad to an Ad Group, the assigned ad may be run against any placements that arise, so long as the ad satisfies the specifications (e.g., dimensions, format type, etc.) of the respective placements.

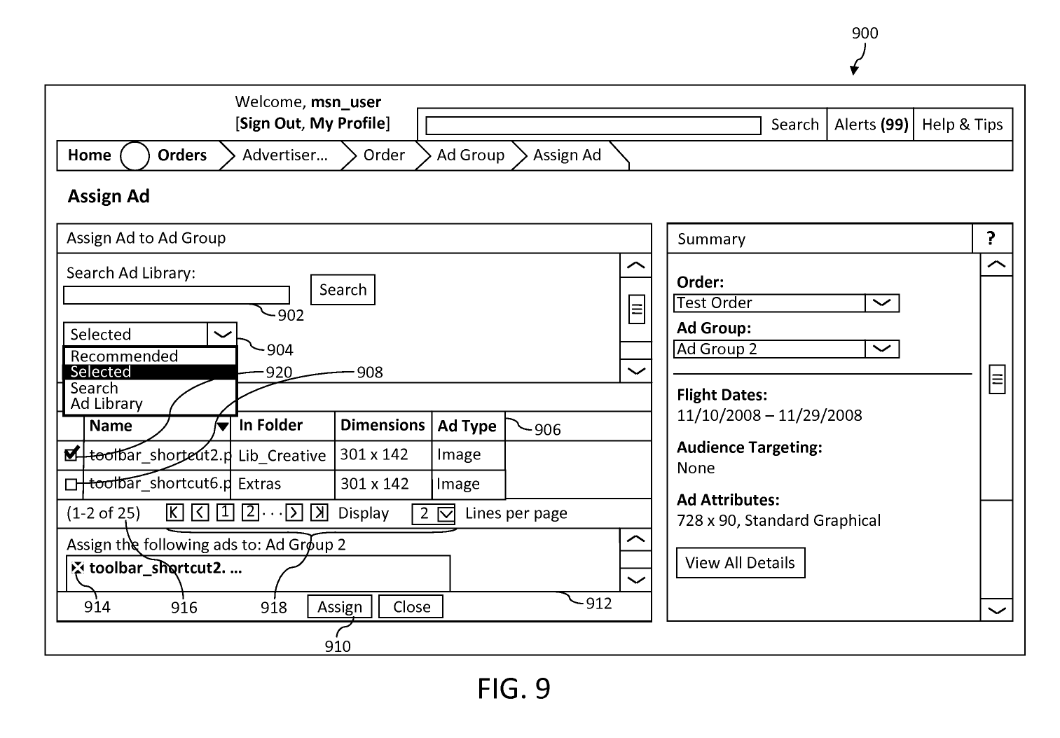

Referring to FIG. 9, a user may utilize search tool 902 to search the Ad Library in the hierarchical folder structure for ads to assign to an Ad Group. For example, content management processing module 202 may execute instructions stored in search module 210₃ of FIG. 2 to provide the functionality associated with search tool 902.

Search type drop down menu 904 enables the user to search among ads grouped based on a variety of predetermined criteria. For example, selecting the “Recommended” item of search type drop down menu 904 enables the user to search among ads recommended by search module 210₃. Content management processing module 202 may recommend an ad in accordance with instructions stored in search module 210₃ in response to the user selecting the “Recommended” item. An ad can be recommended based on any of a variety of factors, including the name of the ad, one or more of the indicators associated with the ad, or other metadata associated with the ad. For instance, content management processing module 202 may execute instructions stored in search module 210₃ to compare the metadata associated with the ad and metadata associated with a placement corresponding to the Ad Group to determine a degree of relevance between the ad and the placement. Ads having degrees of relevance greater than a threshold may be recommended to the user. Alternatively, a predetermined number of ads having relatively high degrees of relevance may be recommended.

The “Selected” item of search type drop down menu 904 enables a user to search among online ads that have been selected by the user. Thus, the scope of a search conducted in accordance with the “Selected” item is restricted to the selected ads. For example, content management processing module 202 may execute instructions stored in search module 210₃ of FIG. 2 to determine which ads have been selected by the user in response to the user selecting the “Selected” item of menu 904. Content management processing module 202 may then search the selected ads in accordance with instructions stored in search module 210₃.

The “Search” item of search type drop down menu 904 enables the user to search the entirety of the Ad Library for an ad. For instance, content management processing module 202 may search the entirety of the Ad Library in accordance with instructions stored in search module 210₃ in response to the user selecting the “Search” item.

The “Ad Library” item enables the user to browse the Ad Library and to select a folder therein to be searched for one or more ads. Thus, the scope of a search conducted in accordance with the “Ad Library” item is restricted to the ads in the selected folder or in sub-folders thereof. For instance, content management processing module 202 may execute instructions stored in search module 210₃ to enable the user to browse the Ad Library and to select a folder therein in response to the user selecting the “Ad Library” item. Content management processing module 202 may then search for the ad(s) in the selected folder in accordance with instructions stored in search module 210₃.

Table 906 lists the ads corresponding to the item of search type drop down menu 904 that is selected by the user. In FIG. 9, the “Selected” item of search type drop down menu 904 is selected for illustrative purposes. Content counter 916 of table 906 shows that twenty-five ads have been selected by the user. Two of those selected ads are shown in table 906, though the ad named “toolbar_shortcut6 . . . ” has been deselected, as indicated by deselected checkbox 908. The names and corresponding information of the remaining selected ads are accessible by using buttons 918. If the user performs a search in this example, the scope of the search is restricted to the twenty-five selected ads, meaning that the search results cannot include ads other than those that have been selected by the user.

The user may select or deselect the checkbox corresponding to each ad listed in table 906, causing the ad to be listed or delisted, respectively, in window 912.

Each ad having a selected checkbox is listed in window 912, indicating that the ad is designated to be assigned to the specified Ad Group (e.g., Ad Group 2 in FIG. 9). An ad listed in window 912 may be deleted from window 912 by deselecting the checkbox corresponding to that ad in table 906 or by selecting the icon next to the name of the ad in window 912. For instance, the user may delete the ad named “toolbar_shortcut2. . . . ” from window 912 by deselecting checkbox 920 in table 906 or by selecting icon 914 in window 912. The user may assign ads listed in window 912 to the specified Ad Group by pressing the “Assign” button 910.

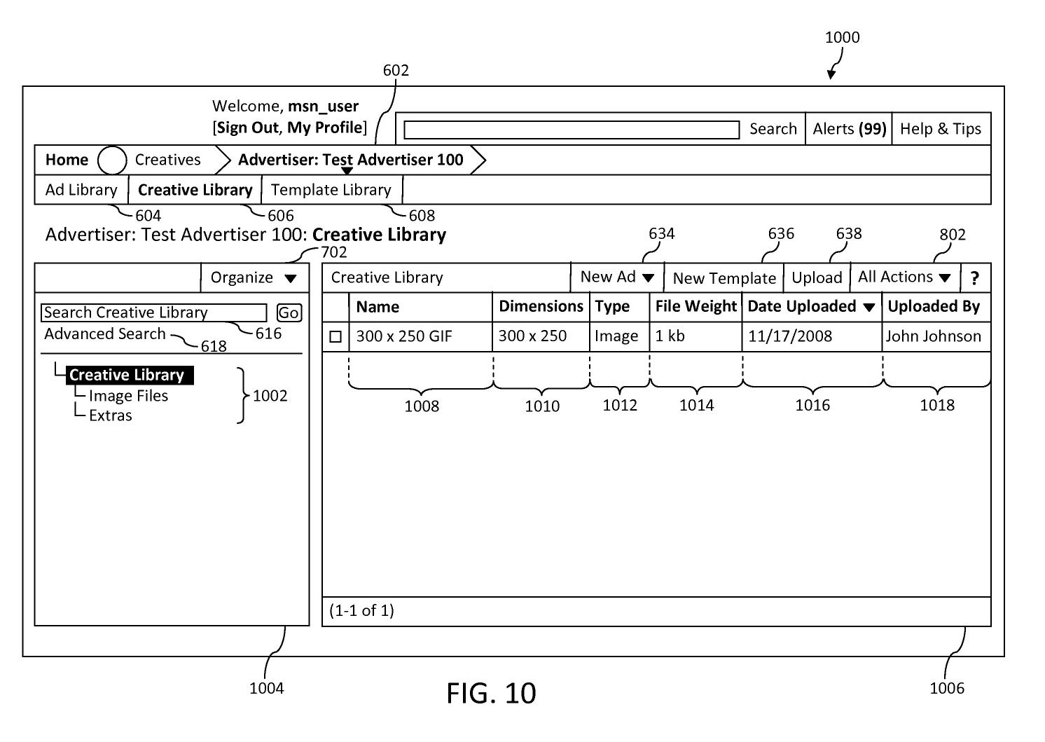

The discussion provided above with reference to the Ad Library 604 of the hierarchical folder structure as shown in FIGS. 6-8 is similarly applicable to the Creative Library 606 of the hierarchical folder structure. For example, folders and creatives in Creative Library 606 may be organized similarly to the folders and ads in Ad Library 604 and by the same organizational operation modules 210₂-210₁₅ described above. As shown in FIG. 10, Creative Library 606 of the provider “Test Advertiser 100” is selected, causing a hierarchical listing 1002 of the folders designated for storing creatives of Test Advertiser 100 to appear in window 1004. When a folder in window 1004 is selected, the creatives that are stored in that folder appear in window 1006. For example, the Creative Library root folder is selected in window 1004, and the only creative stored in the Creative Library root folder (i.e., the creative named “300×250 GIF”) appears in window 1006. The hierarchical listing 1002 of folders in window 1004 is searchable by using search tool 616. Advanced Search tool 618 enables a user to search the hierarchical listing 1002 of folders by specifying a name and/or one or more characteristics of the sought folder(s), thereby filtering the hierarchical listing 1002.

When the name of a creative is listed in window 1006, indicators associated with that creative are listed as well. In FIG. 10, the name of each creative is listed in column 1008. In column 1010, a dimensions indicator specifies the dimensions of the creative. The creative may be any of a variety of types, including but not limited to audio, image, video, etc. For instance, the ad named “300×250 GIF” is listed as being an image type creative in column 1012. In column 1014, a file weight indicator specifies a bit size of the creative. The date that the creative was uploaded to the computer system is specified in column 1016. The name of the individual who uploaded the creative is provided in column 1018.

Organize drop down menu 702 is operable as described above with reference to FIG. 7. All Actions drop down menu 802 enables a user to perform operations on creatives stored in the hierarchical folder structure in a manner similar to that described above with reference to FIG. 8 in the context of online ads. It is noted, that an online ad is more likely to be assigned to an Ad Group than a creative is. Thus, the “Assign to Ad Group . . . ” item of All Action drop down menu 802 is more likely to be utilized for organizing complete online ads.

Users may provide comments and/or dialogue regarding online ad content stored in the hierarchical folder structure via the user interface. Organization module 106 can associate the comments and/or dialogue with the online ad content as metadata, for example, which may be stored by retrieve/store module 210₂ of organization module 106. The metadata may be displayed along with other information regarding the online ad content when the online ad content in the hierarchical folder structure is accessed by a user.

If a user attempts to put multiple copies of the same online ad content in a folder, organization module 106 appends an identifier to the name of each redundant copy of the online ad content to ensure that each copy has a different name. For example, if a user copies an online ad or creative that already exists in a folder of the hierarchical folder structure into that same folder, copy module 210₇ of FIG. 2 may apply a randomly generated number to the filename of the duplicate copy of the ad. Similarly, paste module 210₈ or move module 210₉ of FIG. 2 may apply a randomly generated number to the filename of a copy of an ad that is respectively pasted or moved into a folder that already includes a copy of the ad.

Embodiments of the present invention have a variety of benefits, as compared to conventional online ad networks, such as reducing the overhead and transaction cost associated with conventional networks. For instance, online ads may be generated and/or matched with placements more efficiently than conventional techniques. The embodiments may eliminate the need for uploading ad content every time a new ad is to be created. Embodiments may provide advertisers and/or publishers multiple channels of inventory through a single platform.

When multiple users are involved with an account, embodiments provide a central repository to give all users access to the online ad content associated with the account. For instance, the Web-based hierarchical folder structure described herein is capable of providing a distributed team of different companies working on a common ad campaign access to online ad content associated with the campaign. A client of those companies can also access the online content via the Web-based hierarchical folder structure. Having a central repository for online ad content is beneficial within a single company, as well.

Embodiments may provide controls for auditing work performed with respect to the online ad content stored in the Web-based hierarchical folder structure. For example, an advertiser may determine when a user added an online ad asset to the hierarchical folder structure, which user added it, whether the asset has been added to a folder, whether the asset has been deleted, whether an ad has been generated, etc.

An advertiser may engage another company (e.g., a creative agency) for assistance with an advertising campaign. Traditionally, online ad content generated by such a company is not accessible by the advertiser once the relationship between the advertiser and the company is terminated. Embodiments described herein enable re-use of the online ad content generated by such other company by maintaining the generated online content in the Web-based hierarchical folder structure. This online ad content may be redistributed against similar inventory or similar targets going forward, which is likely to improve overall effectiveness of the advertising campaign while reducing cost.

Organization module 106 enables organization of online ad content in any desired manner. For example, media agencies or creative agencies traditionally organize their creative assets or ads on a server in folders that correspond to respective ad campaigns. This folder structure may be incorporated into the Web-based hierarchical folder structure described herein. Accordingly, the Web-based hierarchical folder structure may enable users to find online ad content relatively easily (e.g., by browsing through the hierarchical folder structure or performing a free-form search). In another example, the Web-based hierarchical folder structure may be configured to enable a user to access and/or organize online ad content for multiple ad campaigns across multiple advertisers in parallel, streamlining the ability of the user to organize the online ad content.

Embodiments described herein may be capable of generating ads from third party sources. For instance, organization module 106 may be configured to store a piece of code that represents a creative hosted on a third party system. Organization module 106 may be configured to retrieve the creative based on the stored code to generate an ad for storage in the Web-based hierarchical folder structure or for substantially instantaneous delivery to a visitor of a publisher's a Web site.

One concern associated with conventional online ad networks is the amount of memory space required to store the online ads. Web-based organization of the online ad content using organization module 106 is capable of mitigating such concerns by providing a substantially unlimited amount of memory space for storage of the online ads and other online ad content. Another concern associated with conventional online ad networks is the difficulty associated with finding a stored online ad. Embodiments described herein may provide a variety of integration points between different applications accessible through the user interface to facilitate finding desired online ad content and performing a desired organizational operation regarding that online ad content.

It should be noted that the user interface also enables a user to search publisher inventory to determine which Web site(s) should be used for placement of an ad. The user may filter the publisher inventory based on any of a variety of criteria, including but not limited to the target audience and/or visitor information associated with the Web site(s). The target audience may be defined using behavioral, geographic, and/or demographic factors. The visitor information may indicate the number of impressions, visitors, clicks, actions, conversions, or engagements that are associated with the Web site(s). The visitor information may be associated with a representative ad campaign, a designated period of time, etc. A publisher can similarly manage its inventory via the user interface. Publishers may be provided with multiple channels of demand, which may increase overall monetization of the publisher inventory.

A user may utilize software that is capable of fetching data related to online ad content in a hierarchical configuration. The user may utilize an interface provided by organization module 106 or the user's own interface to access the Web-based hierarchical folder structure and to utilize the organizational functionality described herein.

Embodiments described herein are applicable to graphical online ad content, video online ad content, audio online ad content, textual online ad content (e.g., sponsored link ads), etc.

### F. Example Computer System Implementation

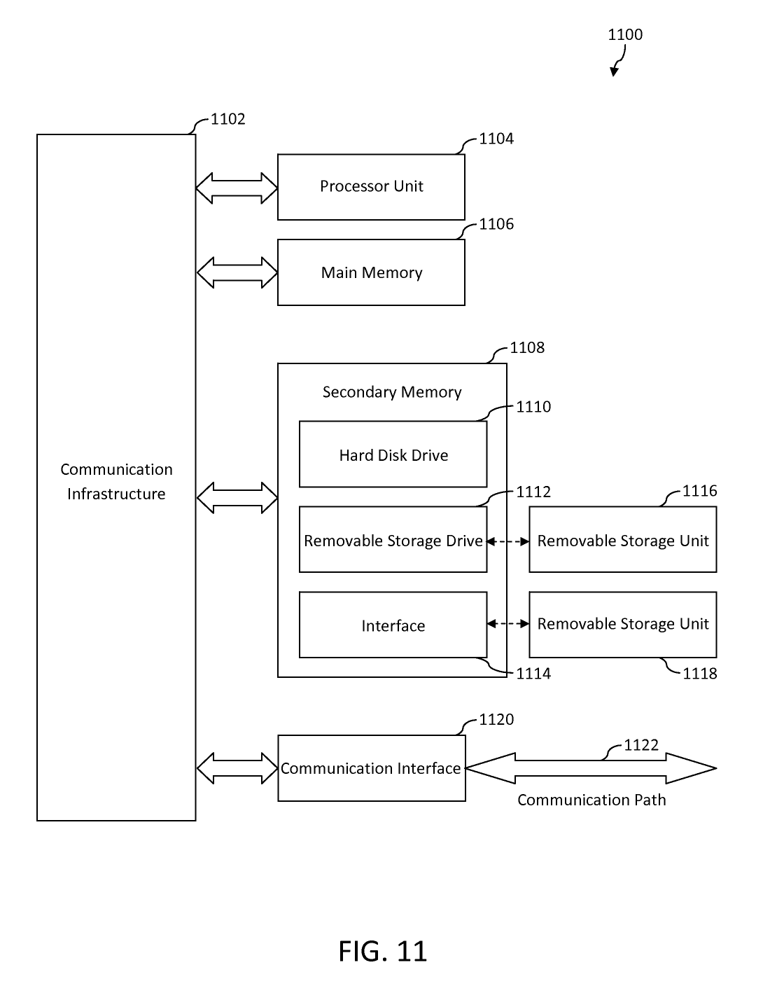

Each of the elements of the example online ad network 100 and example organization module 106 depicted in respective FIGS. 1 and 2, and each of the steps of flowcharts 400 and 500 depicted in FIGS. 4 and 5, may each be implemented by one or more processor-based computer systems. An example of such a computer system 1100 is depicted in FIG. 11.

As shown in FIG. 11, computer system 1100 includes a processor unit 1104 that includes one or more processors. Processor unit 1104 may include content management processing module 202 of FIG. 2 or a portion thereof, for example, though the scope of the present invention is not limited in this respect. Processor unit 1104 is connected to a communication infrastructure 1102, which may include, for example, a bus or a network.

Computer system 1100 also includes a main memory 1106, preferably random access memory (RAM), and may also include a secondary memory 1108. Secondary memory 1108 may include, for example, a hard disk drive 1110, a removable storage drive 1112, and/or a memory stick. Removable storage drive 1112 may comprise a floppy disk drive, a magnetic tape drive, an optical disk drive, a flash memory, or the like. Removable storage drive 1112 reads from and/or writes to a removable storage unit 1116 in a well-known manner. Removable storage unit 1116 may comprise a floppy disk, magnetic tape, optical disk, or the like, which is read by and written to by removable storage drive 1112. As will be appreciated by persons skilled in the relevant art(s), removable storage unit 1116 includes a computer readable medium having stored therein computer software and/or data.

In alternative implementations, secondary memory 1108 may include other similar means for allowing computer programs or other instructions to be loaded into computer system 1100. Such means may include, for example, a removable storage unit 1118 and an interface 1114. Examples of such means may include a program cartridge and cartridge interface (such as that found in video game devices), a removable memory chip (such as an EPROM or PROM) and associated socket, and other removable storage units 1118 and interfaces 1114 which allow software and data to be transferred from the removable storage unit 1118 to computer system 1100. It will be apparent to persons skilled in the relevant art(s) that storage 204 of FIG. 2 may be included in main memory 1106, secondary memory 1108, removable storage unit 1116, removable storage unit 1118, or some combination thereof, though the scope of the present invention is not limited in this respect.

Computer system 1100 may also include a communication interface 1120. Communication interface 1120 allows software and data to be transferred between computer system 1100 and external devices. Examples of communication interface 1120 may include a modem, a network interface (such as an Ethernet card), a communication port, a PCMCIA slot and card, or the like. Software and data transferred via communication interface 1120 are in the form of signals which may be electronic, electromagnetic, optical, or other signals capable of being received by communication interface 1120. These signals are provided to communication interface 1120 via a communication path 1122. Communication path 1122 carries signals and may be implemented using wire or cable, fiber optics, a phone line, a cellular phone link, an RF link and other communication channels.

As used herein, the terms “computer program medium” and “computer readable medium” are used to generally refer to media such as removable storage unit 1116, removable storage unit 1118 and a hard disk installed in hard disk drive 1110. Computer program medium and computer readable medium can also refer to memories, such as main memory 1106 and secondary memory 1108, which can be semiconductor devices (e.g., DRAMs, etc.). These computer program products are means for providing software to computer system 1100.

Computer programs (also called computer program logic, computer control logic, programming logic, or logic) are stored in main memory 1106 and/or secondary memory 1108. Computer programs may also be received via communication interface 1120. Such computer programs, when executed, enable computer system 1100 to implement features of the present invention as discussed herein. Accordingly, such computer programs represent controllers of the computer system 1100. Where the invention is implemented using software, the software may be stored in a computer program product and loaded into computer system 1100 using removable storage drive 1112, interface 1114, or communication interface 1120.

The invention is also directed to computer program products comprising software stored on any computer readable medium. Such software, when executed in one or more data processing devices, causes a data processing device(s) to operate as described herein. Embodiments of the present invention employ any computer readable medium, known now or in the future. Examples of computer readable mediums include, but are not limited to, primary storage devices (e.g., any type of random access memory) and secondary storage devices (e.g., hard drives, floppy disks, CD ROMS, zip disks, tapes, magnetic storage devices, optical storage devices, MEMs, nanotechnology-based storage device, etc.).

### G. Conclusion

While various embodiments of the present invention have been described above, it should be understood that they have been presented by way of example only, and not limitation. It will be understood by those skilled in the relevant art(s) that various changes in form and details may be made therein without departing from the spirit and scope of the invention as defined in the appended claims. Accordingly, the breadth and scope of the present invention should not be limited by any of the above-described example embodiments, but should be defined only in accordance with the following claims and their equivalents.

What is claimed is:

1. A method comprising:
providing a Web-based hierarchical folder structure that is accessible to a plurality of remote users via the World Wide Web; and
organizing online ad content among a plurality of folders in the Web-based hierarchical folder structure in response to a command received from a remote user of the plurality of remote users.

2. The method of claim 1, wherein organizing the online ad content includes creating a folder in the hierarchical folder structure to store at least one of an online ad, a creative, or a template for an online ad.

3. The method of claim 1, wherein organizing the online ad content includes copying or moving at least one of a first folder of the plurality of folders or an online ad from the first folder to a second folder of the plurality of folders.

4. The method of claim 1, wherein organizing the online ad content includes deleting at least one of a first folder of the plurality of folders or an online ad from the first folder.

5. The method of claim 1, wherein organizing the online ad content includes organizing a creative independently from an ad to which the creative corresponds.

6. The method of claim 5, wherein organizing the creative includes copying or moving the creative from a first folder of the plurality of folders to a second folder of the plurality of folders.

7. The method of claim 5, wherein organizing the creative includes deleting the creative from a folder of the plurality of folders.

8. The method of claim 1, further comprising:
retrieving a creative from a remote source based on code stored in the hierarchical folder structure;
generating an online ad that includes the creative; and
storing the online ad in the hierarchical folder structure.

9. The method of claim 1, further comprising:
associating at least one of a status indicator, an editorial indicator, or a traffic indicator with the online ad content.

10. A method comprising:
providing online ad content to a Web-based hierarchical folder structure that is accessible to a plurality of remote users via the World Wide Web; and
organizing the online ad content among a plurality of folders in the Web-based hierarchical folder structure.

11. The method of claim 10, further comprising:
executing program code that periodically retrieves information regarding the hierarchical folder structure.

12. The method of claim 10, further comprising:
retrieving a hierarchically structured portion of the hierarchical folder structure via the World Wide Web.

13. A computer program product comprising a computer-readable medium having computer program logic recorded thereon for enabling a processor-based system to organize online advertising content in a Web-based hierarchical folder structure that is accessible to a plurality of remote users on the World Wide Web, comprising:
a first program logic module for enabling the processor-based system to provide the Web-based hierarchical folder structure; and
a second program logic module for enabling the processor-based system to organize the online ad content among a plurality of folders in the Web-based hierarchical folder structure in response to a command received from one or more of the plurality of remote users.

14. The computer program product of claim 13, wherein the second program logic module includes instructions for enabling the processor-based system to create a folder in the hierarchical folder structure to store at least one of an online ad, a creative, or a template for an online ad.

15. The computer program product of claim 13, wherein the second program logic module includes instructions for enabling the processor-based system to copy or move at least one of a first folder of the plurality of folders or an online ad from the first folder to a second folder of the plurality of folders.

16. The computer program product of claim 13, wherein the second program logic module includes instructions for enabling the processor-based system to delete at least one of a first folder of the plurality of folders or an online ad from the first folder.

17. The computer program product of claim 13, wherein the second program logic module includes instructions for enabling the processor-based system to organize a creative independently from an ad to which the creative corresponds.

18. The computer program product of claim 17, wherein the instructions for enabling the processor-based system to organize the creative include instructions for enabling the processor-based system to copy or move the creative from a first folder of the plurality of folders to a second folder of the plurality of folders.

19. The computer program product of claim 17, wherein the instructions for enabling the processor-based system to organize the creative include instructions for enabling the processor-based system to delete the creative from a folder of the plurality of folders.

20. A system comprising:
a content management processing module; and
a storage coupled to the content management processing module for storing
a database module that includes online ad content,
a first organizational operation module for enabling the content management processing module to provide a Web-based hierarchical folder structure including the online ad content that is accessible to a plurality of remote users on the World Wide Web, and
a second organizational operation module for enabling the content management processing module to organize the online ad content among a plurality of folders in the Web-based hierarchical folder structure in response to a command received from one or more of the plurality of remote users.
